(19) United States
(12) Patent Application Publication
(10) Pub. No.: US 2022/0360686 A1
(43) Pub. Date: Nov. 10, 2022

(54) PRINT MATERIAL ELEMENT SETS

(71) Applicant: HEWLETT-PACKARD DEVELOPMENT COMPANY, L.P., Spring, TX (US)

(72) Inventors: Sergio Etchebehere Juan, Sant Cugat del Valles (ES); Peter Morovic, Sant Cugat del Valles (ES); Jan Morovic, London (GB)

(73) Assignee: HEWLETT-PACKARD DEVELOPMENT COMPANY, L.P., Spring, TX (US)

(21) Appl. No.: 17/634,190

(22) PCT Filed: Sep. 3, 2019
(86) PCT No.: PCT/US2019/049321

§ 371 Date: Feb. 9, 2022

(51) Int. Cl. H04N 1/52; H04N 1/50; H04N 1/23

(52) U.S. Cl. CPC H04N 1/52; H04N 1/502; H04N 1/233

(57) ABSTRACT

In an example, a method includes determining, by processing circuitry, an element set to be associated with a print addressable location for printing an article in a one-pass print mode. The element set may comprise a plurality of elements, wherein each element identifies a print material or print material combination and is associated with a probability that the print material or print material combination identified by that element is to be applied to the associated print addressable location. Determining the element set for printing in a one-pass print mode may comprise favouring elements identifying individual print materials over elements identifying print material combinations.

### BACKGROUND

Printing systems may convert input data (for example, data representing an image for two-dimensional printing, or data representing an object for three dimensional printing) to print instructions, which specify where print materials (for example, colorants such as inks or toners or other printable materials) are to be placed in a print operation.

Examples of techniques used in converting data may include use of threshold matrices, in which a particular print material or material combination is assigned a probability of being applied in a particular location and the choice is made by comparing the probability values for the location to a threshold value. For example, a print material may be selected such that a drop of a particular color ink will be placed at a particular pixel to form an image.

### BRIEF DESCRIPTION OF DRAWINGS

Examples are now described with reference to the accompanying drawings in which;

FIG. 1 is an example method for determining an element set for a one-pass print mode;

FIG. 2 is an example method for determining a color mapping resource for a one pass print mode;

FIGS. 3A-3D show examples of the effect of different element sets and different clustering behaviour;

FIG. 4 is an example method for printing an article;

FIG. 5 is an example of apparatus comprising processing circuitry;

FIG. 6 is an example of a print apparatus; and

FIG. 7 is a block diagram of an example non-transitory machine readable medium associated with a processor.

### DETAILED DESCRIPTION

Some printers have a mode in which they deposit print materials while scanning in two directions, known as bidirectional printing (as printing occurs while scanning in two direction), single pass printing, or one-pass printing (as each portion of substrate is traversed once). Bidirectional/one-pass printing can reduce printing time, because it avoids the wasted motion of moving printheads without printing. However, bidirectional printing can introduce a print quality defect known as “hue shift”, which arises when colors are overprinted in different orders depending on the direction of the printheads.

To consider an example where hue shift may arise, in a particular printer, a printhead deposits ink of a different color on the media. Drops of the colored inks can be combined in the same pixels to form a range of perceived colors to the human eye. For example, superimposing drops of magenta and cyan in the same pixel location produces a blue composite color pixel. If there were no interactions between the ink and the print media (or substrate), the order in which the magenta and cyan ink drops were deposited on the print media may have no effect. However, the ink and the media may interact, and thus the color shade or hue that is perceived by the observer may depend on the order in which the drops of the different colorant are deposited on the media.

The arrangement of the print cartridges in the carriage may cause a differing order of drop deposition that creates a hue shift between different regions of what should be the same color in bidirectional printing. In an example inkjet printer, cyan, black, magenta, and yellow printheads may be aligned side-by-side in a carriage. When the carriage sweeps in a forward direction, the yellow printhead may pass over a particular pixel location on the print media first, followed by the magenta, then the black, and finally the cyan. If a blue color is to be printed in a print addressable location, the magenta drop would be deposited before the cyan in such a system. In contrast, when the carriage sweeps in the rearward direction, the cyan printhead will pass over a particular print addressable location on the print media first, followed by the black, magenta, and then yellow printheads. If a blue color is to be printed in a print addressable location, the cyan drop would be deposited before the magenta. The two ‘blues’ could appear different to a viewer of the printed output.

Other examples may include print materials other than inks, and/or more colors, some of which may be lighter and darker versions of a given color shade.

In the case of two-dimensional printing. a print addressable location may be represented by at least one pixel, and each print addressable location may be printed with at least one colorant such as inks (for example cyan, magenta, yellow and black inks), coatings or other print materials, as well as combinations of those print materials.

In the case of three-dimensional printing, which is also referred to as additive manufacturing, three-dimensional space may be characterised in terms of ‘voxels’, i.e. three-dimensional pixels, wherein each voxel occupies or represents a discrete volume. In examples of three-dimensional printing therefore, an addressable area may correspond to at least one voxel and each voxel may be ‘printed’, i.e. generated or manufactured, using one or a combination of printed agents and/or build materials.

To briefly discuss three-dimensional printing in greater detail, objects generated by an additive manufacturing process may be formed in a layer-by-layer manner. In one example, an object is generated by solidifying portions of layers of build material. In examples, the build material may be in the form of a powder or powder-like material, or may be a fluid or a sheet material. In some examples, the intended solidification and/or physical properties may be achieved by printing an agent onto a layer of the build material. Energy may be applied to the layer and the build material on which an agent has been applied may coalesce and solidify upon cooling. In other examples, directed energy may be used to selectively cause coalescence of build material, or chemical binding agents may be used to solidify a build material. In other examples, three-dimensional objects may be generated by using extruded plastics or sprayed materials as build materials, which solidify to form an object, and may be colored in a post processing step.

In examples herein, possible print materials to be applied to an addressable location to provide a particular color are specified within an element set, which may be referred to as a vector. In some examples, the print materials may be identified explicitly, i.e. in a set of elements comprising a set of print materials and/or print material combinations. In other examples, it may be that at least one of the elements of an element set relates to another quality, which may in turn be related to print materials. For example, an element may specify a property or the like which can be mapped to print materials.

In some examples, a set of elements is expressed as a print material coverage representation which defines print material data, for example detailing (explicitly or implicitly, for example via a mapping) the amount of print materials (such as a colorant or coating for two dimensional printing or an agent(s) to be deposited onto a layer of build material, or in some examples, build materials themselves for three dimensional printing), and, if applicable, their combinations.

For example, a print addressable location within input data (for example, a pixel in image data or a voxel in object model data) may be associated with an element set. The element set(s) may include element which specify (directly or via a mapping) print materials and print material combinations which may be applied to the location, each element being associated with a probability of being applied to that location. In the case of two-dimensional printing, these may be referred to as area coverage vectors and/or, when the set of elements comprise the Neugebauer Primaries (NPs), as Neugebauer Primary Area Coverage vectors (NPac vectors, or simply NPacs herein), which are the possible print material amounts and combinations which may be applied to a single print addressable location. In the case of three-dimensional printing, these may be referred to as volume coverage vectors, Material Volume coverage vectors (also termed Mvoc vectors, or simply MVocs, herein), which may also specify combinations of print agents, may be defined.

For example, for a binary (bi-level) printer, an NP is one of 2^{k} combinations of k print agents within the printing system, wherein print agents can be represented in single-drop states, in a k-dimensional color space.

As noted above, such element sets provide a probability that a print material or a combination of print materials may be applied in a location. In a simple case, an element set may indicate that the particular print material or print material combination should be applied to that location on X % of occasions, whereas on (100−X)% of occasions the location should be left clear of the print material. In practise, this may be resolved at the addressable resolution for the print material and/or printing device. Therefore, if there are N addressable locations in an XY plane associated with such an element set, around X % of these N locations may be expected to receive a print material, while around (100−X)% do not. This region of the XY plane may be intended to be perceived as a color associated with the element set.

For example, in a printing system with two available print materials (for example, inks, coatings or agents), identified as M1 and M2, where each print material may be independently deposited in an addressable area (e.g. voxel or pixel) as single drop, there may be 2² (i.e. four) probabilities in a given Mvoc or NPac coverage vector: a first probability for M1 without M2; a second probability for M2 without M1; a third probability for an over-deposit (i.e. a combination) of M1 and M2, e.g. M2 deposited over M1 or vice versa; and a fourth probability for an absence of both M1 and M2 (indicated as Z herein). In this example, it is assumed that a drop of print material may be applied or not: i.e. a binary choice may be made and the value for each agent may be either 0 or 1. The full set of NPs of the example printing system are therefore M1, M2, M1M2 and Z.

In this case, a vector or element set may be: [M1:P1, M2:P2, M1M2:P3, Z:P4] or with example probabilities [M1:0.2, M2:0.2, M1M2:0.5, Z:0.1]—in a set of print addressable locations (e.g. and [x, y] or an [x, y, z] location (which in some examples may be a [x, y] location in a z slice)) to which the element set applies, and on average, 20% of locations are to receive M1 without M2, 20% are to receive M2 without M1, 50% are to receive M1 and M2 and 10% are to be left clear (Z).

In non-binary systems, there may be more elements defined describing the different amounts of print agent and/or associated combinations of print agents, which may be applied (i.e. there may be more NPs). As each value is a proportion and the set of values represent the available material combinations, the set of probability values in each element set generally sum to 1 or 100%. Where the probability associated with an NP is zero, then that NP may be (effectively of actually) from the vector/element set.

This may be compared to another example of a print coverage vector in which the area/volume coverage is controlled but the ‘at pixel’ or ‘at voxel’ choices are not (“print agent vectors” herein). For example, a print coverage vector may specify that X % of a region receives agent M1 and Y % receives agent M2, but the overprinting of agents is not explicitly defined (although the sum of X and Y may be greater than 100, so overprinting may result).

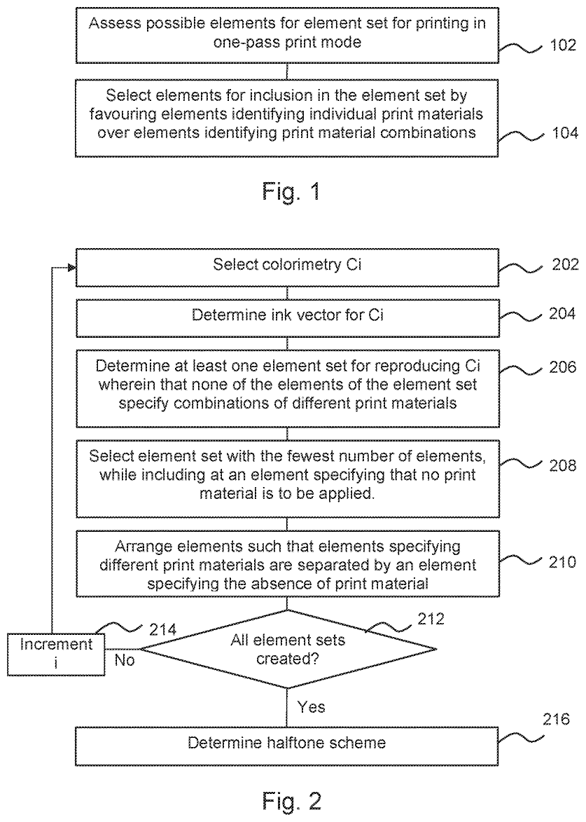

FIG. 1 is an example of a method, which may be a computer implemented method of determining an element set, which may be carried out by one or more processors. The element set may be one of a plurality of element sets, which may for example be intended for inclusion in a color mapping resource. The element set may be intended to provide an area or volume coverage vector such as an NPac or MVoc.

The method comprises determining, by processing circuitry, an element set to be associated with a print addressable location for printing an article in a one-pass print mode. The element set comprises a plurality of elements, each element identifying a print material or print material combination. Each element is associated with a probability that the print material or print material combination identified by that element is to be applied to the associated print addressable location. The elements may comprise NPs. The elements of the element sets may provide explicit choices for applying to the print addressable locations. In other words, exactly one element of an element set may be selected when printing an article, and the associated print material or print material combination may be applied to the print addressable location (and no other print material).

Block 102 comprises assessing possible elements for an element set for printing in a one-pass print mode and, in block 104 selecting elements for inclusion in the element set by favouring elements identifying individual print materials over elements identifying print material combinations.

To consider a particular example, the element set may be intended to reproduce a particular color, for example a green color. It may be determined that the green color may be produced by 66% of yellow ink coverage (Y) and 64% of cyan ink coverage (C), on a system using CMYK inks with capability of firing single or double drops.

There are a number of ways in which the coverage may be produced.

For example a first element set could be specified as:

[Y: 36%, C: 34%, CY: 30%]

A second element set could specif here YY and CC indicates that two drops of that colorant is applied):

[YY: 33%, CC: 32%, Z: 35%]

When comparing these two element sets, it can be seen that, while they provide the same overall coverage of each colorant the second element set contains elements identifying individual print materials whereas the first element set also comprises elements identifying print material combinations (CY overprinting). Therefore, in order to minimise the hue differences associated with bi-directional (or one-pass) printing, the second element set may be favoured over the first element set.

While in some examples, overprinting with different colorants may be avoided altogether, there may be other factors which are taken into account when selecting an element set for inclusion in a mapping resource. For example, elements sets which minimise the use of black ink may be associated with lower image graininess than those which include large amounts of black ink. There may in some cases be system and/or substrate thresholds to the maximum number of drops which can be applied in a single printing pass, for example based on the firing frequency of the drops and/or an intended print speed.

Therefore, while in some examples, the method of FIG. 1 may result in selection of an element set in which there is no overprinting specified using different colors in a single print addressable location (i.e. elements identifying individual print materials are favoured over elements identifying print material combinations such that print material combinations are avoided entirely), there may be occasions where some overprinting is allowed if other factors take precedent, for example when other print criteria are considered.

In such an example, favouring elements identifying individual print materials over elements identifying print material combinations may comprise increasing a weighting or probability that such an element set may be selected. For example, elements identifying individual print materials may contribute positively to a ‘score’ or assessment of the element set and/or elements identifying print material combinations may contribute negatively to the assessment or score. There may be other factors which contribute to the assessment/score (for example a predicted low level of grain), which may in some cases outweigh the presence of element(s) identifying print material combinations in a selected element set. The relative weighting of such factors, and other factors, may vary between use cases.

In summary then, in some examples, favouring elements identifying individual print materials over elements identifying print material combinations may comprise assessing element sets, wherein elements identifying individual print materials contribute positively to the assessment and/or elements identifying print material combinations contribute negatively to the assessment.

In some examples, the attributes of an element set may be determined using theory and/or by printing test samples. The attributes of a ‘good’ element set may vary based on factors such as the apparatus being used to print an article, the use case (e.g. is it for a magazine, to be read by a user at a close distance, or a poster, to be seen from metres away), substrate/print media material, print materials such as choice of ink or the like. Therefore, the relative weight given to each print quality factor (with reducing overprinting with different print materials being one such factor) when assessing an element set may vary.

Such considerations also apply when considering different element sets which could be used which result in single-color deposits. For example, a third element set could be [Z: 35%, YY: 33%, CC: 32%], which includes the same elements as the second element set in a different order, and a fourth element set may be [Y: 34%, YY: 16%, C: 36%, CC: 14%], which again avoids over-printing.

Examples of selection between such element sets are discussed in relation to FIG. 2 below.

The element set may be used in due course to determine print instructions by selecting one of the elements for a particular location when reproducing the color. The method of FIG. 1 therefore reduces the chances that a print instruction for printing a color associated with the element set will specify overprinting. However, even if all the elements relate to individual elements, there is still a possibility that overprinting may result, for example due to dot-placement errors, small ‘satellite’ drops forming as print material is ejected, and/or irregular drop shapes. FIG. 2 provides an example of a method to further reduce such overprinting.

FIG. 2 is an example of a method, which may be a computer implemented method for developing a color mapping resource mapping a plurality of colors to respective element sets, which may be carried out by one or more processors.

Block 202 comprises selecting a colorimetry Ci and block 204 comprises determining a print material vector (in this example an ink vector) associated with that colorimetry. For example, as mentioned above, the colorimetry may be a particular green, and the ink vector may specify coverages of print materials as, for example, a 66% coverage for yellow (Y) and a 64% coverage of cyan (C).

Block 206 comprises determining at least one element set for reproducing Ci with the specified coverages wherein the element set is determined such that none of the elements specify combinations of different print materials (or in other words such that each element relates to a single print material or to an absence of print material). In other words, in this example, overprinting with combinations of print materials is avoided altogether.

Block 208 comprises selecting the element set determined in block 206 with the fewest number of elements, while including at least one element specifying that no print material is to be applied. Selecting the element set with a low number of elements allows for greater control as to the relative placement of those elements. Moreover, including an element specifying that no print material is to be applied can allow for creation of a ‘buffer zone’ between materials of different colors to reduce accidental overprinting, as is discussed in greater detail below. In some examples, additional conditions may be considered at this stage, such as thresholds relating to ink amounts and/or selecting a relatively high probability of ‘no print material’ (i.e. a relatively high Z probability) which may result in a high quality output. However the selection of the element set may also depend on other factors, such as predicted printing system error, ink-media iteration, cluster size and the like, which may be taken into account. For example, as mentioned above, element sets may be assessed against a plurality of criteria, with the weighting of each criteria possibly varying based on any or any combination of intended use case, print material/substrate choice, print apparatus, intended print quality, user preferences or the like.

Block 210 comprises arranging the elements of the element set such that elements identifying different print materials are separated by an element specifying the absence of print material. In some examples, this may comprise dividing the element specifying that no print material is to be placed into multiple elements. For example, there may be a plurality of Z elements specified, having a predetermined cumulative probability. However, as block 208 has selected the element set with the smallest number of elements, it may be relatively common that there are just two types of print materials specified in the element set.

It may be noted that it has previously been proposed that elements in vectors such as NPacs and MVocs are ordered by lightness as this tends to promote image smoothness. However, this method (in particular in conjunction with the halftoning scheme described below), allows the blank space to act as a buffer zone between print locations which are likely to receive a first print material and those which are likely to receive a second print material.

Block 212 comprises determining if all intended element sets have been created. If not, i is incremented (block 214), and the method loops back to block 202 with a new selected colorimetry. The method therefore determines a plurality of element sets for printing in a one-pass print mode which include elements identifying individual print materials, and no elements identifying print material combinations, wherein each of the element sets is to provide a different printed colorimetry Ci.

If, or once, all intended element sets have been created, the method proceeds to block 216, which comprises determining a halftone scheme for determining which element of the element set is selected for printing the article in a one-pass printing mode. In this example, determining the halftone scheme comprises selecting a halftone scheme which results in clustering of an element in the printed article. For example, the selected halftone scheme may have attributes of a green noise distribution.

To consider an example of a threshold matrix, it is possible to design such matrices to enhance or to reduce clustering. So-called ‘blue noise’ distributions tend to result in dots of a particular color being dispersed relatively evenly over an area, whereas ‘green noise’ distributions are associated with clustering, for example by including clustering of higher threshold values and clustering of lower threshold values. However, there is no well-defined point at which a ‘blue noise’ distribution becomes a ‘green noise’ distribution. Rather, there is a continuum, with a varying tendency towards clustering. Blue noise distributions can result in smooth images, but green noise, or clustered distributions, may, in particular in conjunction with the arrangement of the element sets described in relation to block 210, provide for separation between drops of different colors and therefore may reduce even accidental over printing.

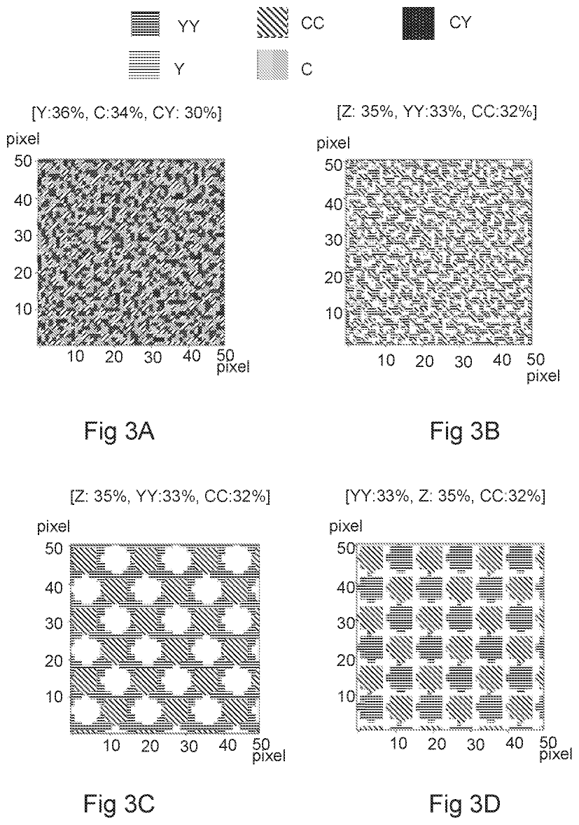

To discuss this in more detail, reference may be made to FIGS. 3A-D, which illustrate how choices in the element set may be used to reduce hue shift in bidirectional, one-pass or single pass, print modes. Each of the FIGS. 3A-3D shows a 50 by 50 grid of pixels which are associated with a given element set, although the element set is configured differently for the different figures. The element set associated with each of the FIGS. 3A-3D provides the same overall ink coverage, in this example being based on the 66% yellow, 65% cyan green color discussed above.

FIG. 3A illustrates an example of an element set which allows overprinting, and which has been printed using a ‘blue noise’ type halftoning threshold matrix. In particular, the element set in this case is the first element set mentioned above: [Y: 36%, C: 34%, CY: 30%]. The threshold matrix comprises an array of threshold values between 0 and 99, each value associated with one of the pixels. When selecting an element, the elements are compared to a threshold of the threshold matrix in order, with their probabilities accumulating, and the first element associated with a cumulative probability above the threshold is selected. Thus (assuming integer values are used, which need not be the case), if the threshold value for a pixel is 0-35, Yellow is selected. If the value is 36-69, Cyan is selected and for values of 70 and above, an ‘overprint’ of cyan and yellow is selected. This overprint could result in significant hue differences when printing in different directions. Therefore, in some examples, while the first element set may be a good option for multi-pass print modes, in which each substrate portion may be printed to in multiple passes (and examples of print apparatus may be operable in both multi-pass and single pass print modes), it may be a sub-optimal choice for a single pass print mode as it may result in hue shift.

FIG. 3B shows an example using a third element set (which corresponds to the first element set mentioned above, ordered from lightest to darkest, in a manner known to provide smooth images), and using a dispersed dot, or blue noise type, distribution. The element set allows selection of no print material, two drops of yellow or two drops of cyan: [Z: 35%, YY: 33%, CC: 32%]. In an ideal system, this would result in no overprinting with different colors. However, in the event of drop misplacement, satellite drops or misshapen drops, some overprinting may occur.

FIG. 3C shows the effect of using a more clustered distribution, with the same element set as used in FIG. 3B. In this case, the threshold matrix is arranged such that values in a value sub-range tend to be clustered, resulting in relatively large single color areas. This will reduce any accidental overprinting, which may now be seen in the borders of the clusters, but is unlikely to be seen in the centre of the clusters.

FIG. 3D shows the effect of using a more clustered distribution (in this example, the same distribution as is seen in FIG. 3C). However, while the element set used has the same elements as in FIGS. 3B and 3C, these are reordered as [YY: 33%, Z: 35%, CC: 32%]. This has the effect of separating the yellow and cyan clusters, which are associated with lower and higher threshold values, with white borders. As such, any misplaced drops, satellite drops or misshapen drop parts are likely to fall within the unprinted area, and overprinting with different colors is further reduced.

It may be noted that image smoothness may decrease as cluster sizes increase. Moreover, the tolerance for overprinting and the possibility of hue shift may vary for different applications. Therefore, these factors may be balanced according to, for example, user priorities, use cases, apparatus accuracy and the like.

As has been noted above, there is a large variety of possible element sets which could be derived from a given ink vector that keep different print materials separate. For instance, the 66% yellow, 64% cyan coverage ink-vector could be expressed as: Z: 35%, YY: 33%, CC: 32%] or [Y: 34%, YY: 16%, C: 36%, CC: 14%], or many other possibilities. All these possible element sets have different properties: for example, an element space that has more blank media will allow more space between clusters, but on the other hand, these will tend to be associated with larger drop-states (i.e. are more likely to specify more than one drop, or a larger drop, for a pixel), and larger drop states can be associated with higher drop-placement errors.

As noted above, selection of a particular element set may depend on apparatus, materials, intended use case and the like, and therefore the element set selected may be determined with reference to such factors. Thus, different candidate element sets (which may for example be generated randomly or deterministically, and/or according to predetermined principles) may be assessed relative to criteria other than overprinting with different colors, and a candidate element set which performs well against such criteria may be selected for use.

The optimal sizes of the clusters, the choices in relation to the elements of the element states, the order of the elements and the like, may depend on properties of printing systems and/or user priorities. For instance, a printing system which produces irregular drop shapes or is associated with higher drop placement error (or is otherwise associated with accidental overprinting) may result in the selection of a halftone matrix with a tendency to produce larger clusters and/or with a larger probability associated with no print material (a higher value for Z) than for printing systems which are less likely to result in accidental overprinting.

More generally, the approach described here can be used to make explicit choices about the printed output in terms of the hue shift artefacts.

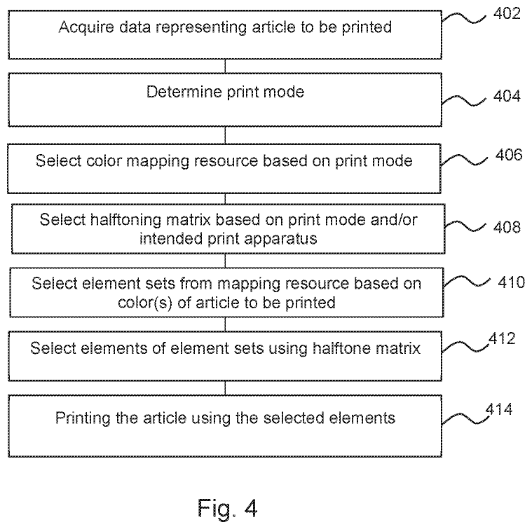

FIG. 4 shows an example method of use of a color mapping resource such as the resource derived in FIG. 2.

Block 402 comprises acquiring, by processing circuitry, data representing an article to be printed. For example, this may comprise text, an image, an object model or the like, which is to be printed on a substrate, or generated using additive manufacturing. The data may specify, for each of a plurality of print addressable locations, an intended color. The color may be expressed in any color space, and may in some examples be a color space which is independent of any print apparatus (a “device independent color space”). For example, the device independent color space may be sRGB, Adobe RGB, or may be some other color space, for example a color space which uses an International Commission on Illumination (CIE) color model. Other color space models include Hue-Saturation-Value (HSV), Hue-Saturation-Lightness (HSL), Yule-Nielsen-corrected XYZ, XYZ, LAB or the like

Block 404 comprises determining the print mode. The method then proceeds to block 406, which comprises selecting a color mapping resource based on the print mode. If the print mode determined in block 404 is one-pass (or bi-directional), block 406 may comprise selecting at least one element set favouring elements identifying individual print materials over elements identifying print material combinations. For example, this may comprise selecting a “one-pass color mapping resource”, such as a resource derived as set out in FIG. 2. If the determination in block 404 is for a multiple pass mode, different element sets/mapping resources may be selected, for example including those with elements specifying, or even favouring, overprinting of different print materials.

Block 408 comprises selecting a halftoning matrix having a dot-cluster attribute based on at least one of the print mode and the print apparatus on which the image is to be printed. For example, this may comprise selecting a halftoning matrix which produces relatively large clusters if the selected print mode is a one pass print mode and the selected print apparatus is associated with a relatively high level of drop placement errors and a relatively small cluster size if the drop placement of the print apparatus is known to be accurate. If the determination in block 404 is for a multiple pass mode, then hue shift may be less of a concern and a halftoning matrix which is less likely to result in clustering such as ‘blue noise’ type matrices, or which result in smaller clusters, may be selected to enhance image smoothness.

Block 410 comprises, for each print addressable location (e.g. pixel or voxel), selecting an element set based on the color of the article to be printed in that print addressable location. This may use a color mapping resource mapping between colors specified in the data describing the article to be printed and the element sets.

Block 412 comprises selecting an element of each element set based on the halftone threshold value associated with that print addressable location, wherein the halftone value is from the selected halftone matrix. This provides a print instruction for each print addressable location corresponding to a pixel/voxel of the data representing the article to be printed. A set of print addressable location s corresponding to a particular element set will be perceived to have a predetermined color, which will be a mix of the individually selected elements.

Block 414 comprises printing the article based on the selected elements in each print addressable location. This may comprise printing in a one-pass print mode (which may also referred to as a single pass mode, a bidirectional print mode, or a single pass bidirectional print mode).

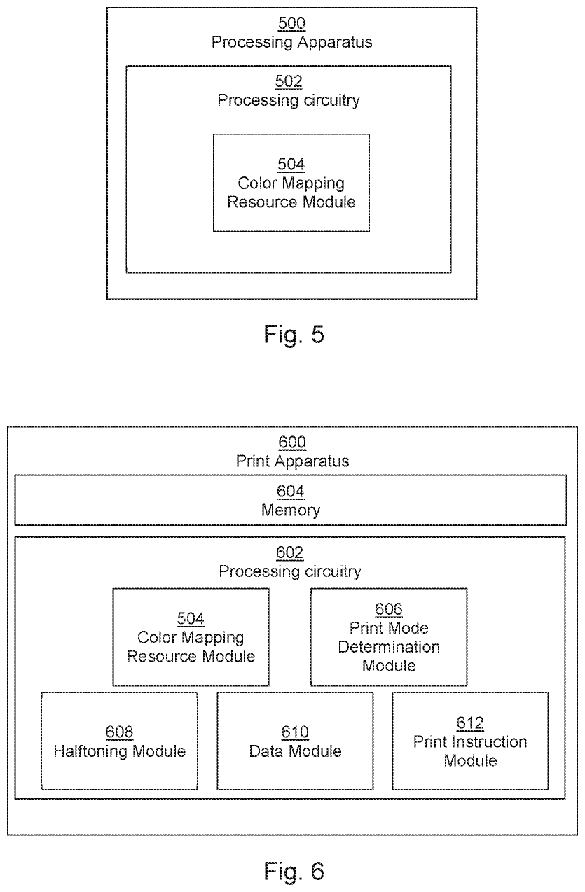

FIG. 5 is an example of apparatus 500 comprising processing circuitry 502 comprising a color mapping resource module 504.

In use of the apparatus 500, the color mapping resource module 504 determines (which may comprise deriving based on the principles set out above, or retrieving from a memory or the like) a one-pass print mode color mapping resource. The one-pass print mode color mapping resource comprises a plurality of element sets to be associated with a print addressable location for printing an article in a one-pass print mode. Each element set comprises a plurality of elements identifying a print material or print material combination associated with a probability that the print material or print material combination identified by that element is to be applied to an associated print addressable location. The one-pass print mode color mapping resource includes elements sets which avoid, entirely or generally, overprinting of print material combinations. For example, the one-pass print mode color mapping resource may be determined so as to reduce or avoid elements which result in overprinting of two different print materials, and/or to provide blank spaces between areas of different print materials, or otherwise based on the principles set out above. For example, the one-pass print mode color mapping resource may comprise element sets in which two elements specifying the application of a print material are interposed with an element specifying a probability of the print location remaining clear of print material. This may provide a ‘buffer zone’ as described above. For example, the element sets of a one-pass print mode color mapping resource may be determined by causing elements relating to a single print material to contribute positively to assessment of an element set and/or by causing elements relating to a combination of different print material to contribute negatively to assessment of an element set.

FIG. 6 shows an example of a print apparatus 600 comprising processing circuitry 602 and a memory 604. The processing circuitry 602 comprises, in addition to the color mapping resource module 504 described above, a print mode determination module 606, a halftoning module 608, a data module 610 and a print instructions module 612.

In this example, the memory 604 stores a plurality of color mapping resources including the one-pass print mode color mapping resource and at least one multi-pass print mode color mapping resource for printing in multi-pass mode. The multi-pass print mode color mapping resource(s) comprise(s) more elements specifying a combination of print materials than the one-pass print mode color mapping resource.

In use of the print apparatus 600, the print mode determination module 606 determines the intended print mode. When the print mode determination module 606 determines that the print mode is a one-pass print mode, the color mapping resource module 504 determines the one-pass print mode color mapping resource by retrieving the one-pass print mode color mapping resource from the memory 604. When the determination is that the print mode is a multi-pass print mode, the color mapping resource module 504 instead retrieves the multi-pass print mode color mapping resource from the memory 604.

In use of the print apparatus 600, the halftoning module 608 selects a halftoning scheme. When the print mode determination module 606 determines that the print mode is a one-pass print mode, the halftoning module 608 selects a clustered dot halftoning scheme for one-pass printing. There may be a plurality of halftoning schemes, and the halftoning module 608 may select a second halftoning scheme for multi-pass printing, wherein the second halftoning scheme is associated with a lower degree of clustering and/or smaller clusters.

The data module 610 acquires data representing an article to be printed. The article may for example comprise a substantially two dimensional image, for example a picture, pattern or text to be applied to a substrate such as paper, card or plastic. In other examples, the article may comprise an object to be printed using additive manufacturing techniques. The instructions may for example include a color description.

The print instruction module 612 determines print instructions based on the acquired data and using the color mapping resource. For example, it may map between a color description and an element set (e.g. an NPac/Mvoc).

The print apparatus 600 prints an article according to print instructions. This may be a two dimensional or three dimensional article. To that end, the print apparatus 600 may comprise additional print apparatus components such as a print head, a print agent supply, and the like. Where the print apparatus 600 is a ‘two-dimensional’ printer, it may comprise an inkjet printer or the like, and may comprise any or any combination of a print head, substrate handling systems, a source of ink or toner, and the like. Where the print apparatus 600 is a ‘three dimensional’ printer, it may comprise, or be associated with any or any combination of a print bed, a fabrication chamber, a print head, an energy source, a source of build material, and the like.

In some examples, the processing circuitry 502, 602 may carry out at least one of the blocks of FIG. 1, FIG. 2 and/or FIG. 4.

The processing circuitry 502, 602, color mapping resource module 504, print mode determination module 606, halftoning module 608, data module 610 and print instructions module 612 may be implemented with one or a plurality of processors executing machine readable instructions stored in a memory, or a processor operating in accordance with instructions embedded in logic circuitry. It is noted that in at least one example described herein, the term “module” refers to a hardware component of the apparatus.

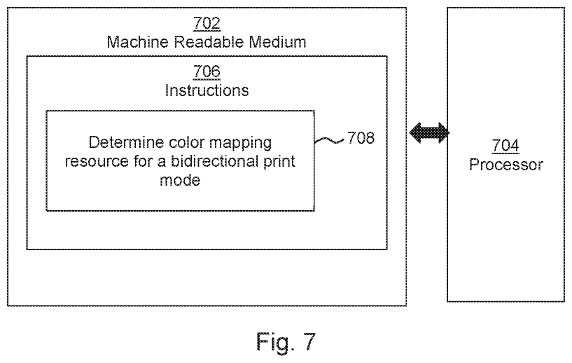

FIG. 7 shows an example of a non-transitory, tangible, machine readable medium 702 in association with a processor 704. The machine readable medium 702 has instructions 706 stored thereon. The instructions 706 when executed by the processor 704 cause the processor 704 to perform processing operations and comprise instructions 708 to cause the processor 704 to determine a color mapping resource for a bidirectional print mode (for example a single pass bidirectional print mode). The color mapping resource comprises a plurality of possible print instructions and the instructions 706 comprise instructions to determine the color mapping resource to reduce (for example, minimise) the probability of selection of print instructions which result in overprinting at a print location with more than one print material when printing a printed output based on the color mapping resource. Determining the color mapping resource may comprise retrieving the color mapping resource from a memory, over a network, or the like. The minimisation may be subject to conditions such as threshold print quality standards such as grain, or apparatus conditions such as print material amounts, an assessment score or the like.

In some examples, the instructions 706 may, when executed by the processor 704 cause the processor 704 to carry out at least one of the blocks of FIG. 1, FIG. 2 and/or FIG. 4.

Examples in the present disclosure can be provided as methods, systems or as a combination of machine readable instructions and processing circuitry. Such machine readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry, or a module thereof, may execute the machine readable instructions. Thus functional modules of the processing circuitry 502, 602 (for example, the color mapping resource module 504, print mode determination module 606, halftoning module 608, data module 610 and print instructions module 612) and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfill the functions of several units recited in the claims.

The features of any dependent claim may be combined with the features of any of the independent claims or other dependent claims.

1. A method comprising:
determining, by processing circuitry, an element set to be associated with a print addressable location for printing an article in a one-pass print mode, the element set comprising a plurality of elements, wherein each element identifies a print material or print material combination and is associated with a probability that the print material or print material combination identified by that element is to be applied to the associated print addressable location,
wherein determining the element set for printing in a one-pass print mode comprises favouring elements identifying individual print materials over elements identifying print material combinations.

2. A method according to claim 1 further comprising determining, by processing circuitry, a halftone scheme for determining which element of the element set is selected for printing the article in a one-pass print mode, wherein determining the halftone scheme for printing the article in a one-pass print mode comprises selecting a halftone scheme which results in clustering of a print material in the printed article.

3. A method according to claim 2 further comprising:
acquiring, by processing circuitry, data representing an article to be printed;
selecting, by processing circuitry, the element set for printing at at least one print location;
selecting, by processing circuitry, an element from the element set using the selected halftone scheme; and
printing the article using the print material or print material identified by the selected element at that print location.

4. A method according to claim 2 wherein the selected halftone scheme is encoded as a halftone matrix.

5. A method according to claim 1, wherein determining the element set for printing in a one-pass print mode comprises determining at least one element which is associated with a probability that no print material is to be applied to a print location, wherein the element which is associated with a probability that no print material is to be applied to a print location is placed in the element set between elements identifying different print materials.

6. A method according to claim 1, comprising determining, by processing circuitry, a plurality of element sets for printing in a one-pass print mode which favour elements identifying individual print materials over elements identifying print material combinations, wherein each of the element sets is to provide a different printed colorimetry.

7. A method according to claim 1 wherein determining the element set comprises:
determining a print material vector specifying coverages of print materials for the element set;
determining elements for the element set which provide the specified coverage such that each element relates to a single print material or to an absence of print material; and
determining an element set which has the fewest number of elements while including an element specifying an absence of print material.

8. A method according to claim 1 comprising:
acquiring, by processing circuitry, data representing an article to be printed;
determining, by processing circuitry, an intended print mode; and
when the intended print mode is a one pass print mode, selecting at least one element set favouring elements identifying individual print materials over elements identifying print material combinations.

9. Apparatus comprising processing circuitry, the processing circuitry comprising:
a color mapping resource module to determine a one-pass print mode color mapping resource, the one-pass print mode color mapping resource comprising a plurality of element sets to be associated with a print addressable location for printing an article in a one-pass print mode, each element set comprising a plurality of elements identifying a print material or print material combination associated with a probability that the print material or print material combination identified by that element is to be applied to an associated print addressable location,
wherein the one-pass print mode color mapping resource is determined to include elements sets which avoid overprinting of print material combinations.

10. Apparatus according to claim 9 further comprising:
a memory storing a plurality of color mapping resources including the one-pass print mode color mapping resource and a multi-pass print mode color mapping resource for printing in a multi-pass print mode, wherein the multi-pass print mode color mapping resource comprises element sets specifying more elements specifying a combination of print materials than the one-pass print mode color mapping resource; and
the processing circuitry further comprises a print mode determination module to determine an intended print mode,
wherein, when the print mode determination module determines that the intended print mode is a one-pass print mode, the color mapping resource module is to determine the one-pass print mode color mapping resource by retrieving the one-pass print mode color mapping resource from the memory.

11. Apparatus according to claim 9 wherein the processing circuitry further comprises a halftoning module to select a halftoning scheme, wherein the halftoning module is to select a clustered dot halftoning scheme for a one-pass printing mode.

12. Apparatus according to claim 9, wherein the one-pass print mode color mapping resource comprises element sets in which two elements specifying application of a print material are interposed with an element specifying a probability of the print addressable location remaining clear of print material.

13. Apparatus according to claim 9 wherein the processing circuitry further comprises:
a data module to acquire data representing an article to be printed; and
a print instruction module to determine print instructions based on the acquired data and using the one-pass print mode color mapping resource.

14. Processing circuitry according to claim 13 further comprising print apparatus to print an article according to the print instructions.

15. A tangible machine readable medium comprising instructions which, when executed by a processor, cause the processor to:
determine a color mapping resource for a bidirectional print mode, wherein the color mapping resource comprises a plurality of possible print instructions and the instructions comprise instructions to determine the color mapping resource to reduce a probability of selection of print instructions which result overprinting at a print location with more than one print material when printing a printed output based on the color mapping resource.
